(19) United States
(12) Patent Application Publication
(10) Pub. No.: US 2007/0154285 A1
(43) Pub. Date: Jul. 5, 2007

(54) Screw with expansion rings

(76) Inventor: Ho Jen Tong, Wanli Township (TW)

Correspondence Address: Chun-Ming Shih, 4331 Stevens Battle Lane, Fairfax, VA, 22033, US

(21) Appl. No.: 11/325,539

(22) Filed: Jan. 5, 2006

(51) Int. Cl. F16B 25/10

(52) U.S. Cl. 411/387.2

(57) ABSTRACT

A screw includes a screw body, a screw head, a screw thread formed on an exterior surface of the screw body and at least one expansion ring formed on the exterior surface to cross the screw thread. The screw thread cuts in a working piece and the expansion ring keeps a gap between the exterior surface and the working piece so that the friction is reduced when screwing.

### BACKGROUND OF THE INVENTION

1. Field of Invention

The present invention relates in general to a screw, and more particularly relates to a screw with at least one expansion ring formed on the surface thereof to reduce the friction caused by the contact of the surface with a working piece when screwing.

2. Related Art

FIG. 6 shows a cross-sectional view of a conventional screw threading in a working piece. The conventional screw includes a screw body 91, a screw head 90 and a screw thread 912 formed on an exterior surface 911 of the screw body 91. When the screw thread 912 cuts in the working piece for screwing, both the exterior surface 911 and the screw thread 912 continuously contact with the working piece. However, a large area of the exterior surface 911 contacted to the working piece will cause greater friction for a user to exert more force to screw.

Therefore, how to reduce the friction caused between the exterior surface 911 and the working piece when screwing is an issue to be solved.

### SUMMARY OF THE INVENTION

The present invention is to provide a screw which can reduce the friction when screwing.

Accordingly, the screw includes a screw body, a screw head, a screw thread formed on an exterior surface of the screw body and at least one expansion ring formed on the exterior surface. The screw thread cuts in a working piece and the expansion ring keeps a gap between the exterior surface of the screw body and the working piece so that the friction is reduced when screwing.

### BRIEF DESCRIPTION OF THE DRAWINGS

The present invention will become more fully understood from the detailed description given hereinbelow illustration only, and thus are not limitative of the present invention, and wherein:

FIGS. 1 to 3 are schematic views of a screw with one, two and three expansion rings, respectively, according to a preferred embodiment of the present invention;

FIG. 4 shows a screw of the present invention screwing in a working piece;

FIG. 5 is a cross-sectional view of FIG. 1 along a line X-X; and

FIG. 6 is a cross-sectional view of a conventional screw threading a working piece.

### DETAILED DESCRIPTION OF THE INVENTION

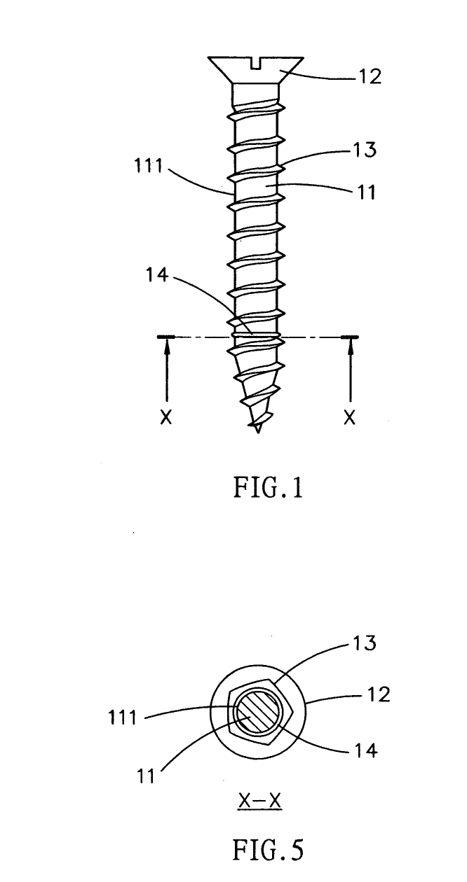

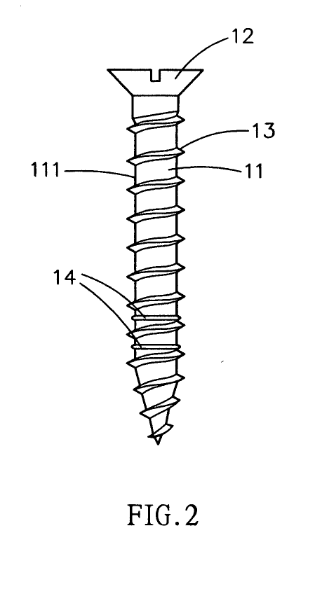

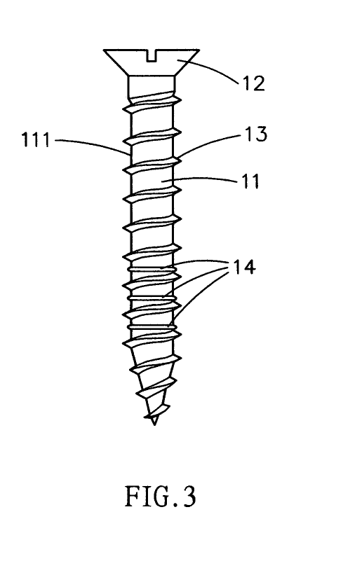

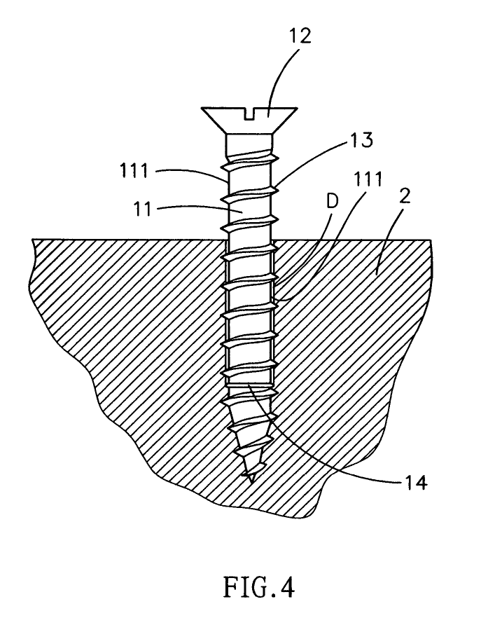

Referring to FIGS. 1 to 5, a screw of the present invention includes a screw body 11, a screw head 12, a screw thread 13 formed on an exterior surface 111 of the screw body 11 and at least one expansion ring 14 protruded from the exterior surface 111. When the screw of the present invention screws to a working piece 2, the screw thread 13 cuts in the working piece 2 and the expansion ring 14 will keep a gap D between the exterior surface 111 and the working piece 2. As such, the friction caused by the continuous contact of the exterior surface 111 with the working piece 2 can be greatly reduced and the user can exert less force to complete the screwing.

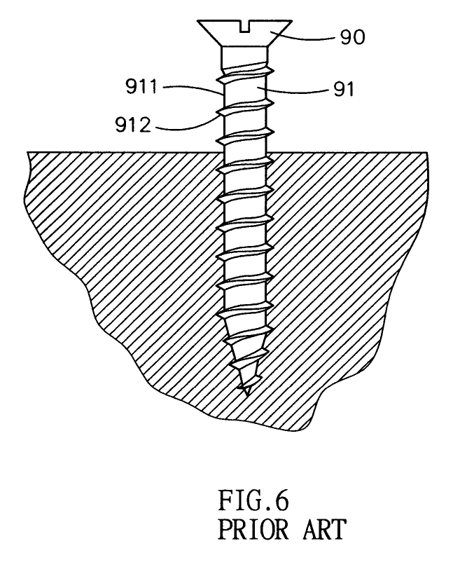

As shown in FIG. 5, a diameter at the expansion ring 14 has to be between a first diameter at the exterior surface 111 and a second diameter at the screw thread 13. That is, a thickness of the expansion ring 14 has to be smaller than that of the screw thread 13.

In FIG. 5, the screw thread 13 shows a pentagonal outline to project in the screw head 12, for example. It doesn't limit the invention. Any other screw with different thread can use the expansion rings disclosed in the present invention to obtain the advantages.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A screw comprising:
a screw body;
a screw head;
a screw thread formed on an exterior surface of the screw body; and
at least one expansion ring formed on the exterior surface,
wherein the screw thread cuts in a working piece and the expansion ring keeps a gap between the exterior surface of the screw body and the working piece so that a friction is reduced when screwing.

2. The screw of claim 1, wherein the screw thread shows a pentagonal outline to project in the screw head.

3. The screw of claim 1, wherein a thickness of the expansion ring is smaller than that of the screw thread.
